(19) United States
(12) Patent Application Publication
(10) Pub. No.: US 2019/0101090 A1
(43) Pub. Date: Apr. 4, 2019

(54) MOTOR VEHICLE STARTER PINION PROVIDED WITH A TOOTH ROOT WITH A VARIABLE RADIUS OF CURVATURE

(71) Applicant: Valeo Equipements Electriques Moteur, Creteil (FR)

(72) Inventors: José Mateus, St Quentin Fallavier (FR); Guy Faucon, St Quentin Fallavier (FR)

(73) Assignee: Valeo Equipements Electriques Moteur, Creteil (FR)

(21) Appl. No.: 16/083,051

(22) PCT Filed: Mar. 7, 2017
(86) PCT No.: PCT/FR2017/050499

§ 371 Date: Sep. 7, 2018

(30) Foreign Application Priority Data
Mar. 11, 2016 (FR) 1652075

(51) Int. Cl. F02N 11/08; F16D 3/06; F16D 3/18; F16H 55/08

(52) U.S. Cl. CPC F02N 11/0851; F16D 3/06; F16H 55/0873; F16H 55/088; F16D 3/185

(57) ABSTRACT

The invention relates mainly to a motor vehicle combustion engine starter motor comprising:—a pinion body comprising splines on its external periphery,—a pinion (31) having an axis (Y), the said pinion (31) being mounted with the ability to move on the pinion body comprising an internal periphery comprising splines (44) engaged with the splines of the said pinion body, the said pinion (31) comprising, on its external periphery,—teeth (42) each having two tooth flanks (47) each comprising:—a working flank (48), and—a tooth root (49) extending from the said working flank (48) of the corresponding tooth (42), characterized in that the said tooth flank (47) comprises at least one tooth root (49) delimited by a curved portion (PC) having a variable radius of curvature.

The present invention relates to a motor vehicle starter pinion provided with a tooth root with variable radius of curvature. The invention has a particularly advantageous application with sintered pinions, but can also be implemented with forged pinions.

In order to start an internal combustion engine, in particular of a motor vehicle, it is known to use a rotary electrical machine in the form of a starter provided with a launcher which can transmit rotational energy of the starter by means of a pinion, to a crankshaft of the thermal engine, by means of a starter ring gear of a thermal engine.

For this purpose, the launcher is fitted such as to be mobile in translation on a drive shaft, between a position of rest, in which the teeth of the drive pinion are disengaged from the teeth of the starter ring gear, and a position of activation, in which the teeth of the drive pinion engage with the teeth of the starter ring gear.

The launcher additionally comprises a pinion body on which the pinion is fitted. The pinion is mobile between an engaged position, and a position compressed in translation relative to the pinion body, in the axial direction. A spring is also fitted on the pinion body between the pinion and a shoulder of the pinion body, exerting a force towards the engaged position. A pinion of this type which is mobile on a pinion body of the launcher makes it possible to facilitate the engagement with a ring gear of a thermal engine which is still running. This is the case in particular for a reinforced starter to carry out the stopping and starting function better known as “stop start”. It is known to use sintered pinions in order to reduce the noise of engagement with the ring gear of the thermal engine. The disadvantage of the sintered material is that it has relatively low mechanical strength. In order to reduce the stress at the tooth root of a pinion corresponding to the area of maximum stress, it is known to increase the radius of the tooth root. However, the increase of this radius gives rise to a decrease of the diameter of the foot of the pinion, which can make the stem of the foot of the pinion too fine to be able to be treated satisfactorily by cementation. In fact, since this type of treatment has a variable effect according to the depth, it would tend to make an excessively fine stem at the foot of the pinion break.

The objective of the invention is to eliminate this disadvantage efficiently by proposing a starter for a thermal engine of a motor vehicle, comprising:
a pinion body comprising ribbing on its outer periphery;
a pinion having an axis, the said pinion being fitted such as to be mobile in translation axially relative to the pinion body, between an engaged position and a position which is compressed relative to the pinion body in the axial direction, the pinion body comprising an inner periphery comprising ribbing engaged with the ribbing of the said pinion body, the said pinion comprising on its outer periphery:
teeth, each comprising two tooth flanks each comprising:
   a working flank; and
   a tooth root which extends from the said working flank of the corresponding tooth, characterised in that the said tooth flank comprises at least one tooth root which is delimited by a curved portion with a variable radius of curvature.

The curved portion with a variable radius of curvature thus makes it possible to optimise the form of the tooth for its engagement with the starter ring gear, whilst having a relatively large tooth root diameter once more. The invention thus makes it possible to reduce the stress, whilst maintaining a maximum amount of material at the diameter of the tooth root of the pinion, in order to improve the mechanical strength of the pinion.

According to one embodiment, the said radius of curvature varies linearly.

This makes it possible to have true continuity of variation. There is no “sudden” or brusque change which could give rise to a stronger concentration of stress, and the solidity is therefore better.

According to one embodiment, the said curved portion is a portion of an ellipse with a large diameter and a small diameter.

This makes it possible to have true continuity of variation. There is no “sudden” or brusque change which could give rise to a stronger concentration of stress, and the solidity is therefore better. In addition, the ellipse is advantageous for control of the part.

According to one embodiment, the said large diameter is inclined relative to a radius of the said pinion.

According to one embodiment, the said large diameter of the ellipse is inclined by an angle of between 45 and 75°.

According to one embodiment, the said angle is approximately 60° plus or minus 5°.

According to one embodiment, the said large diameter is between 20 and 30 mm.

According to one embodiment, the said small diameter is between 5 and 7 mm.

According to one embodiment, a thickness between two successive teeth measured radially relative to the said axis of the said pinion is at least 2.5 mm.

According to one embodiment, the said pinion is made of sintered material.

According to one embodiment, the said pinion has been subjected to treatment by cementation.

According to one embodiment, the said pinion is obtained by cold heading.

According to one embodiment, with each tooth comprising a driven working tooth flank and a drive working tooth flank, the said curved portion is provided on the side of the two flanks.

According to one embodiment, an input face in the ring gear, of each tooth of the pinion, comprises bevelling. This makes it possible to facilitate the insertion of each pinion tooth in the engagement space between two corresponding teeth of the ring gear of the thermal engine of the vehicle such as a car.

According to one embodiment, the pinion body comprises a shoulder, and a spring fitted between the pinion and the shoulder, stressed such as to thrust the pinion towards the engaged position.

According to this embodiment, an element forming an end-of-course stop is also fitted between the end of the pinion body and the pinion, such as to form a stop for the engaged position of the pinion. The element which forms a stop can for example be a resilient ring fitted in an annular groove, or a circlip, or a forced-in washer, or a biasing washer known as a Belleville washer.

The invention will be better understood by reading the following description and examining the figures which accompany it. These figures are provided purely by way of illustration, and in no way limit the invention.

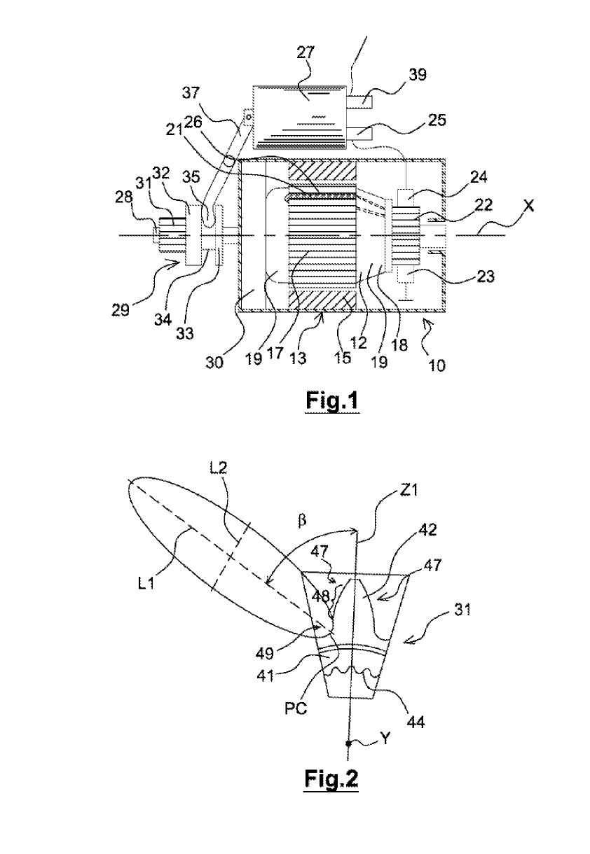

FIG. 1 is a schematic representation from the side of a thermal engine starter according to the present invention;

FIG. 2 is a detailed view of a tooth of the pinion according to the present invention, and of the curvature in the form of an ellipse which makes it possible to obtain the curved form at the tooth root;

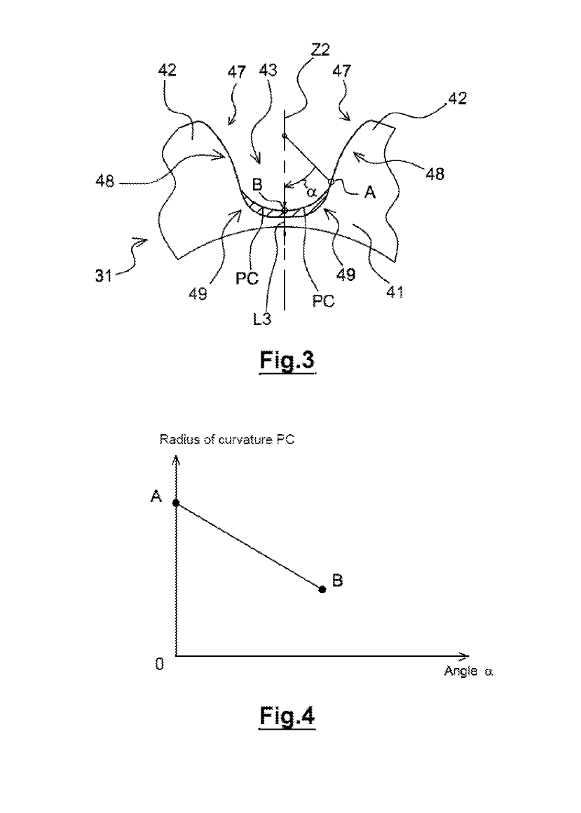

FIG. 3 is a partial view of a pinion, showing the gain in thickness obtained by means of the invention;

FIG. 4 represents a curve of the development of the radius of curvature according to the angle measured at the tooth root;

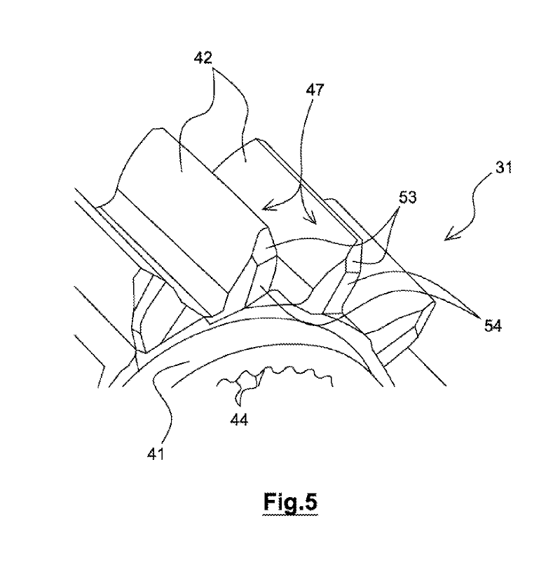

FIG. 5 is a partial view in perspective of a pinion according to the present invention, illustrating the bevelled form provided on the input face of the teeth.

Elements which are identical, similar or analogous retain the same references from one figure to another.

FIG. 1 represents schematically a starter 10 for a thermal engine of a motor vehicle. This direct current starter 10 comprises firstly a rotor 12, also known as an armature, which can rotate around an axis X, and secondly a stator 13, also known as an inductor, positioned around the rotor 12.

This stator 13 comprises a yoke supporting an assembly of permanent magnets 15 which are designed to produce and inductor field. The permanent magnets 15 are formed according to cylindrical segments, whilst being angularly distributed at regular intervals inside the yoke. As a variant, the stator 13 can be a wound stator.

The rotor 12 comprises a rotor body 17 and a winding 18 wound in notches in the rotor body 17. The rotor body 17 consists of a set of metal plates with longitudinal notches 26. In order to form the winding 18, conductive wires in the form of a pin 21 are inserted inside the notches 26, generally on two distinct layers. The winding 18 forms chignons 19 on both sides of the rotor body 17.

At the rear, the rotor 12 is provided with a collector 22 comprising a plurality of contact parts which are connected electrically to the conductive elements of the winding 18, formed by the pins 21 in the example concerned.

A group of brushes 23 and 24 is provided for the electrical supply to the winding 18, at least one of the brushes 23 being connected to the earth of the starter 10, and at least another one of the brushes 24 being connected to an electrical terminal 25 of a contactor 27.

The brushes 23 and 24 rub on the collector 22 when the rotor 12 is rotating, in order to permit the supply to the rotor 12 by switching of the electric current in sections of the rotor 12.

In addition to the terminal 25 connected to the brush 24, the contactor 27 also comprises a terminal 39, which is connected by means of an electrical connection element to an electrical supply of the vehicle, in particular a battery.

The starter 10 also comprises a launcher assembly 29, which is fitted such as to be mobile in translation on a drive shaft 28, and can be rotated around the axis X by the rotor 12.

A speed reducer 30 is interposed between a shaft of the rotor 12 and the drive shaft 28. The launcher assembly 29 comprises a drive element which is formed by a pinion 31, and is designed to be engaged on a drive unit of the thermal engine, such as a starter ring gear of a thermal engine.

The launcher assembly 29 also comprises a free wheel 32, and a washer 33, which define between one another a groove 34 for receipt of the end 35 of a control lever 37. The free wheel 29 comprises an inner track formed on a pinion body on which the pinion is fitted. The pinion is fitted such as to slide axially on the pinion body. The pinion can thus be translated axially relative to the pinion body, between an engaged position, and a position which is compressed relative to the pinion body in the axial direction. In the engaged position, the pinion is further from the free wheel than in the compressed position. The pinion body and the launcher assembly also comprises a spring which is fitted between the track of the free wheel and the pinion. This spring can be compressed in the engaged position. In the compressed position, the spring is more compressed than in the engaged position. The spring thus exerts a force on the pinion relative to the pinion body, towards the engaged position. The assembly also comprises an element forming an end-of-course stop, fitted between the end of the pinion body and the pinion, such as to form a stop for the engaged position of the pinion. The element which forms a stop can for example be a resilient ring fitted in an annular groove, or a circlip, or a forced-in washer, or a biasing washer known as a Belleville washer. The control lever 37 is activated by the contactor 27, in order to displace the launcher assembly 29 relative to the drive shaft 28, along the axis X, between a first position, in which the launcher assembly 29 drives the thermal engine by means of the drive pinion 31, and a second position, in which the drive pinion 31 is disengaged from the starter ring gear of the thermal engine. During the activation of the contactor 27, an inner contact plate (not represented) makes it possible to establish a connection between the terminals 25 and 39, in order to switch the electric motor on.

FIG. 2 shows the pinion 31 with an axis Y, which is designed to be engaged with the starter ring gear of the thermal engine. This pinion 31 comprises a body 41 which has a globally annular form, provided with teeth 42 on its outer periphery. The pinion 31 comprises ribbing 44 on the inner periphery designed to cooperate with toothing with a corresponding form provided in the pinion body. Two adjacent teeth 42 define between one another an engagement space 43 (cf. FIG. 3) in which a tooth of the starter ring gear is designed to be engaged.

Each tooth 42 comprises two tooth flanks 47 which are opposite one another. A distinction is made between a drive flank, which is in contact with the starter ring gear during the phase of driving of the ring gear by the pinion, and a driven flank, which is in contact with the starter ring gear during the phase of driving of the pinion by the starter ring gear.

Each flank 47 comprises a working flank 48, which is designed to come into contact with a corresponding working flank of the starter ring gear, and a tooth root 49, which extends from the corresponding working flank 48.

The tooth roots 49 are delimited by a curved portion PC with a radius of curvature which is variable linearly. In fact, as can be seen in FIG. 4, when displacement takes place on the tooth flank 47 between the points A and B in FIG. 3 according to an angle α, the radius of curvature of the curved portion PC tends to decrease linearly.

As illustrated by FIG. 2, the curved portion PC is a portion of an ellipse with a large diameter L1 and a small diameter L2. The large diameter L1 is inclined relative to the radius of the pinion 31 which passes via the axis of symmetry Z1 of the corresponding tooth 42. The large diameter L1 is inclined by an angle β of between 45 and 75°, and of approximately 60° plus or minus 5°. According to one embodiment, the large diameter L1 is between 20 and 30 mm, whereas the small diameter L2 is between 5 and 7 mm. The curved portions PC opposite one another of two successive teeth 42 are symmetrical relative to an axis Z2 situated between the two teeth 42 (cf. FIG. 3).

The curved portions PC thus make it possible to optimise the form of the teeth 42 for their engagement with the starter ring gear, whilst having a relatively large diameter tooth root diameter once more. The invention thus makes it possible to maintain a maximum amount of material at the tooth root 49 diameter in order to improve the mechanical strength of the pinion 31. The hatched part in FIG. 3 thus shows the gain in thickness obtained in comparison with a conventional pinion in this area situated between the diameter of the base and the diameter of the foot, defined by a profile with a form extending in the manner of a circle followed by a constant radius of connection with the tooth root 49 diameter. The profile can be in trochoid form for a cut pinion. The thickness L3 between two successive teeth 42 measured radially relative to the axis of the pinion 31 is thus at least 2.5 mm.

As can be seen clearly in FIG. 5, an input face in the ring gear, of each tooth 42, comprises bevelling 53 in order to facilitate the insertion of each tooth 42 in the engagement space between two corresponding teeth of the ring gear. This bevelling 53 is provided on an axial end face 54 of each tooth 42 with an orientation which is radial relative to the axis Y of the pinion.

The pinion 31 can be a sintered pinion 31 obtained by compacting a powder based on iron and carbon in an appropriate mould. A production process of this type makes it possible to obtain easily the form of an ellipse at the tooth root.

In order to improve its mechanical strength, the pinion 31 can be subjected to treatment by cementation. This operation consists of thermochemical treatment, i.e. it is a high-temperature heat treatment which is accompanied by modification of the chemical composition of the basic alloy by enrichment and diffusion of carbon provided by an atmosphere of the furnace which is rich in a carbon element. Since the pinion 31 to be treated is in contact with this atmosphere rich in carbon in the treatment furnace, the carbon will then enrich the surface and subsequently be diffused to a certain depth, thus creating a gradient of concentration of carbon which decreases from the surface and to a certain depth, until the initial carbon content of the alloy is obtained once more.

Once this high-temperature step has been carried out, a quenching operation is then carried out consisting of a stage of sudden cooling of the part. This will make it possible to obtain transformations of metallurgical structures and modifications of hardness in order to obtain a hardness profile which decreases in the entire cemented surface layer (from the surface and to a certain depth). Finally, the parts are not left in the untreated quenched state (otherwise they would be very fragile). The parts are subjected to a stress-relieving anneal which has a slight impact on the hardness on the surface and in its vicinity, i.e. to a depth of approximately 0.2 mm for example, but not on the remainder of the hardness profile.

Alternatively, the pinion 31 is obtained by cold heading.

It will be appreciated that the foregoing description has been provided purely by way of example, and does not limit the field of the invention, a departure from which would not be constituted by replacing the different elements by any other equivalents.

1. A starter for a thermal engine of a motor vehicle, comprising:
a pinion body comprising ribbing on its outer periphery;
a pinion having an axis, the pinion being fitted to be mobile in translation axially relative to the pinion body, between an engaged position and a position which is compressed relative to the pinion body in the axial direction, the pinion body comprising an inner periphery comprising ribbing engaged with the ribbing of the said pinion body, the said pinion comprising on its outer periphery:
teeth, each comprising two tooth flanks each comprising:
a working flank; and
a tooth root which extends from the said working flank of the corresponding tooth,
wherein the said tooth flank comprises at least one tooth root which is delimited by a curved portion with a variable radius of curvature.

2. The starter according to claim 1, wherein the said radius of curvature of the said curved portion varies linearly.

3. The starter according to claim 1, wherein the said curved portion is a portion of an ellipse with a large diameter and a small diameter.

4. The starter according to claim 3, wherein the said large diameter is inclined relative to a radius of the said pinion.

5. The starter according to claim 4, wherein the said large diameter of the ellipse is inclined by an angle of between 45 and 75°.

6. The starter according to claim 5, wherein the said angle is approximately 60° plus or minus 5°.

7. The starter according to claim 3, wherein the said large diameter is between 20 and 30 mm.

8. The starter according to claim 3, wherein the said small diameter is between 5 and 7 mm.

9. The starter according to claim 1, wherein a thickness between two successive teeth measured radially relative to the said axis of the said pinion is at least 2.5 mm.

10. The starter according to claim 1, wherein the said pinion is made of sintered material.

11. The starter according to claim 10, wherein the said pinion has been subjected to treatment by cementation.

12. The starter according to claim 1, wherein the said pinion is obtained by cold heading.

13. The starter according to claim 1, wherein with each tooth comprising a driven tooth flank and a drive tooth flank, the said curved portion is provided on the side of the two flanks.

14. The starter according to claim 1, wherein an input face in the ring gear, of each tooth of the said pinion comprises bevelling.
